(19) United States
(12) Patent Application Publication
(10) Pub. No.: US 2013/0316903 A1
(43) Pub. Date: Nov. 28, 2013

(54) Solid Plant Nutrient Compositions

(71) Applicant: Kenneth D. Hughes, Alpharetta, GA (US)

(72) Inventor: Kenneth D. Hughes, Alpharetta, GA (US)

(21) Appl. No.: 13/868,097

(22) Filed: Apr. 22, 2013

Related U.S. Application Data
(60) Provisional application No. 61/636,537, filed on Apr. 20, 2012.

(51) Int. Cl. C05G 3/00

(52) U.S. Cl. CPC C05G 3/0094
USPC 504/102; 71/21

(57) ABSTRACT

Plant and soil nutrient compositions are provided in solid unitary bodies using worm castings. Solid bodies are created in easily recognizable shapes and carry major and minor plant nutrients, soil enhancers, beneficial microorganisms, plant materials, and combinations thereof. Solid bodies containing plant and soil nutrients can be used on substrate surfaces, underground in plant root zones, and to prepare liquid preparations for use in agriculture and landscape care.

### CROSS-REFERENCE TO RELATED APPLJCATION

This application claims priority to and the benefit of the filing date of U.S. provisional application, Ser. No. 61/636,537, entitled “Solid Plant Nutrient Compositions,” filed on Apr. 20, 2013, which is entirely incorporated herein by reference.

### FIELD OF THE INVENTION

The present invention relates generally to solid shaped plant and soil nutrient products and to processes for producing such solid shaped plant and soil nutrient products using natural components. More particularly, it relates to production of solid shaped products prepared using worm castings that exhibit strong binder characteristics. The invention also generally relates to the use of solid shaped products and unitary bodies that can carry, protect, and deliver plant and soil nutrients, microbial inoculants, beneficial soil organisms and plant materials such as seeds and root material. The invention further relates to processes for producing solid shaped plant and soil nutrient compositions in important and aesthetically interesting forms. Products of the invention find wide application in agriculture, horticulture, landscaping, and general plant and vegetation care.

### PRIOR ART

It is well known in the art to provide solid synthetic plant nutrients and fertilizers in the shapes of pellets, spikes, briquettes, and mats to support plant growth. Solid forms prepared for delivering synthetic plant nutrients typically incorporate synthetic binders for immobilization of components and often include significant amounts of inert materials or fillers that have limited use by plants or for improving soils. Solid forms prepared for delivering plant nutrients can utilize fast release nutrients in salt form, slow release nutrients in polymer form, or combinations thereof. A wide variety of commercial products using these methods are available. Exemplary prior art includes U.S. Pat. No. 3,057,713, to Gessler, titled “Fertilizer Sticks,” which describes the use of powdered synthetic fertilizers in combination with asbestos minerals which yield a product with sufficient strength to be pounded into the ground. U.S. Pat. No. 3,892,552, to Gay Jr. et al., titled “Fertilizer,” describes rigid one-piece molded spikes containing fertilizers in slow release form and the use of minimum quantities of water insoluble thermoset resins.

U.S. Pat. No. 6,120,574, to Moore, describes the use of ph sphate ion and thermoplastic adhesives to prepare attrition resistant fertilizer spikes. Likewise, U.S. Pat. No. 5,803,946 to Petcavich et al., discloses a controlled release nutrient formulation using urea, insoluble polymers, and tung oil. U.S. Pat. No. 5,435,821, to Duvdevani et al., discloses controlled release nutrient materials using sulfonated polymers. U.S. Pat. No. 5,089,041 to Thompson et al., and U.S. Pat. No. 5,219,465 to Goertz discloses the use of polyvinyl polymers to encapsulate fertilizers and sulfur coated fertilizer materials for controlled release, respectively. US application No. 2002/0178772A1 by Hince, discloses methods for producing slow release nutrient granules using inorganic geochemical binders containing phosphorus.

US application No. 2006/0089259A1, by Philipp , titled “Method of Making a Rigid Unitary Fertilizer Composite,” uses polyacrylamide as an insoluble inert binder for fertilizer pastes. U.S. Pat. No. 5,549,730, to Aoki, titled, “Compression Molded Tablet Fertilizer and Method The Production Thereof,” describes compressed slow release fertilizer tablets that incorporate molding agents including ste.aric acid. US application No.2006/0089259A1, by Driessen et al., titled “Shaped Plant Growth Nutrient Products and Processes for the Production Thereof,” uses a biodegradable water soluble thermoplastic polymeric binding agent. Preferred shapes are tablets. U.S. Pat. No. 6,350,531B1, to Sugimoto et al., titled “Biodegradable Plastic Molded Article,” uses a biodegradable polymeric binding agent along with a water swelling fiber and fertilizer to produce biodegradable products with controlled degradation.

US application No. 2009/0282733A1 by Moore et al., titled “Mulch Mat with Fertilizer and Realistic Appearance,” uses a molded elastomeric mat to provide mulch and fertilizer to the soil surface around a plant. A synthetic water insoluble polymer binder is used to prepare the mat.

The combination of plant materials and fertilizers has also been described heretofore. U.S. Pat. No. 6,088,957, to Kazemzadeh, titled “Seed-Containing Fertilizer Package,” describes the use of thermally processed organic waste materials as carriers for seeds. The use of cavities in the solid fertilizer shapes protects the seeds for transport.

Worm excretions and manures, commonly called worm castings have been collected and purposefully produced and utilized for many years. Worms are commonly cultured (vermiculture) for food as well as bait for fishing. There is active and growing interest in using worms to convert and stabilize organic wastes including manures to useable materials. Worm castings are a highly variable material varying widely in chemical and physical characteristics such as moisture content, nutritional value, inherent microbial populations, and general manipulability. Wide variations in quality and characteristics are a result of differences in worm food type and composition, feeding schedules, environmental conditions, as well as worm species type. There are many different species of worms and many are difficult to identify without genetic analysis.

It is well known to use worm castings in loose particulate form alone or mixed with feedstock and carbonaceous materials. The latter is often called vermicompost. Worm castings are an ideal organic natural fertilizer for all plant species and their use in agriculture, gardening, and horticulture has been well documented in public literature. The major plant nutrients nitrogen, phosphorus, and potassium as well as many micronutrients and trace elements are present in worm castings and their natural disposition in the material is understood to provide significant advantages over synthetic plant fertilizer preparations. However, worm castings are poorly understood with respect to chemical and physical properties and factors that control material variability.

There is an immediate need for solid shaped forms of plant and soil nutrients that utilize natural materials for binding plant and soil nutrients, for carrying microbial inoculants, and for storing and delivering plant materials, and soil organisms. There is also a need for improving the aesthetics of solid shaped forms of plant nutrients for commercial markets, consumer products, and education.

### SUMMARY OF THE INVENTION

Solid shaped forms that can deliver plant nutrients rapidly or through slow release mechanisms are valuable across many commercial and scientific fields including agriculture, horticulture, landscaping, food production, gardening, bioremediation, and biomass production for energy. Intelligently designed nutrient delivery systems are important for optimizing plant growth and yield as well as for protecting the environment. There is strong and growing interest in preparing solid shaped forms of natural plant nutrients using natural components.

The metabolic excretions of worms are called worm castings and it has been discovered, unexpectedly, that certain preparations can be used to replace synthetic binders in solid shaped forms or unitary bodies. The material binding characteristics of worm castings of the invention can be used to prepare solid shaped forms or unitary bodies from all natural materials and can be used for the delivery of plant and soil nutrients, microbial inoculants, as well as plant materials. Shaped forms of the invention can be easily handled, manipulated, packaged, stored, transported, and marketed to the general public in familiar and interesting shapes. Shaped solid forms of the invention are highly suitable for delivering complex mixtures of plant nutrients, soil nutrients, microorganisms in active and dormant states, plant materials, a wide range of soil amendments, as well as plant and soil active chemicals and compounds from both synthetic and natural sources.

As the utility of the materials and methods of this invention are far reaching and provide significant benefits that have not been previously described in the field of preparing and applying solid forms and unitary bodies of worm excretions, there are numerous objects of this invention. Those objects described herein are to be viewed as exemplary.

It is therefore an object of this invention to replace synthetic binders used in preparing solid shaped forms of plant nutrients with natural excretions from worms. It is an object of this invention to prepare solid shaped forms of plant and soil nutrients in common shapes such as pellets, balls, spikes, and briquettes, as well as in forms that are more aesthetic and interesting to the general public. Solid shaped forms can be produced in the form of plants, flowers, animals, abstract shapes, sea life, famous sculptures and artifacts and in shapes that are well recognized by children and adults

It is an object of this invention to prepare solid shaped forms for containing, storing, and delivering plant and soil nutrients, microorganism inoculants, dormant and active forms of microorganisms, soil organisms and viable plant materials such as seeds and roots. It is also an object of this invention to deliver useful agriculture, horticulture, and gardening chemicals, compounds, and microorganisms from synthetic sources, natural sources, and combinations thereof.

It is an object of this invention to provide stable mixtures and compositions of plant nutrients including synthetic fertilizers, minerals in solid and water soluble forms, and amendments as well as organic fertilizers derived from plant and animal materials, manures, composts and combinations thereof. It is also an object of this invention to include in solid shaped forms natural plant nutrient compositions derived from fish, algae, animal and plant excretions and extracts, and fermented as well as oxidized materials.

It is an object of this invention to prepare and utilize solid shaped forms for terrestrial and aquatic plant growth, food production, agriculture, horticulture, landscaping, gardening, bioremediation, and biomass production for energy. Likewise, it is an object of this invention to prepare materials for education, scientific research, and decoration.

### BRIEF DESCRIPTION OF FIGURES

FIG. 1, is an illustration of the front face of a solid form of the invention in a well recognized shape of a butterfly. The solid butterfly form is one inch in length and width.

FIG. 2, is a cross sectional view of a solid form of the invention, placed flush with the surface of the soil and containing a single viable plant seed.

### DETAILED DISCUSSION

It is well known to use worm castings in loose particulate form and as vermicompost. Worm castings are an ideal organic natural fertilizer for all plant species and their use in agriculture, gardening, and horticulture is established but limited, Worm castings contain all major plant nutrients nitrogen, phosphorus, and potassium as well as many micronutrients and trace elements.

It has been found, unexpectedly, that worm castings can be produced that have strong material binding characteristics and that the binding characteristics are sufficiently strong to create solid shaped forms and solid unified bodies. ft has also been discovered that the binder like qualities of appropriately prepared worm castings material can produce rugged rigid forms suitable for containing, storing, and delivering particulate materials useful in agriculture, horticulture, gardening, landscaping, lawn care, and bioremediation. It has also been discovered that traditional manufacturing methods such as molding and extrusion can be used to produce solid forms of worrn castings that are rigid and strong enough to be handled, manipulated and commercialized through traditional avenues.

Worm castings in accordance with the present invention may be produced using worms that are readily available and found in or near agriculture operations world-wide. Exemplary worm species appropriate for use in the present invention include Eisenia fetida,, Eisenia andrei, Lumbricus rubellus, and Lumbricus terrestris. Preferred species include Eisenia fetida, Eisenia andrei, Lumbricus rubellus, and related species.

Exemplary systems for housing the worms for production of the worm castings of the present invention include protected enclosures that avoid direct ground contact of worms and worm castings. Enclosures may be range in size greatly and may be supported at ground level or elevated above ground, Enclosures can range in size from 0.25 m³ to 50 m³. Preferred sizes are between 0.5 m³ and 25 m³. Experts in the field of vermiculture. will understand how to support and implement enclosures in this size range as well as outside these ranges. Preferred elevated worm casting production systems include systems developed and operated by Skolex Biotechnologies and described in US application No. 20120214223A1, and is included herein in its entirety by reference.

Environmental conditions suitable for maintaining worms and producing worm castings of the present invention include temperatures in the range between 45 and 90 degrees Fahrenheit. Preferred temperatures are between 55 and 85 degrees Fahrenheit. Environmental conditions at the boundaries of this temperature range slow worm castings production and reduce worm health and activity. Exemplary moisture levels of worm castings and feed-stocks used to produce the worm castings of this invention when in contact with worms range from 30% to 90% by weight. Preferred moisture content is between 50% and 80%.

Food sources and feed-stocks suitable for meeting the nutritional requirements of the worms and producing worm castings of the present invention include protein and carbohydrate containing materials, and easily digested natural materials containing a high percentage of carbon. Exemplary protein materials include those obtained from animal and plant products, manures, and composts. Preferred protein materials include those derived from plant materials including grains, nuts, and coffee grounds. A wide variety of carbohydrate containing materials can be used and exemplary carbohydrates include starches, grains, grasses, and are obtained from plant materials, Preferred carbohydrates include vegetables, fruits, and starches. Exemplary carbon containing materials include woody biomass, and commercially produced cellulose and natural fiber materials. Preferred materials include cardboard and paper materials. In general, preferred materials for producing worm castings of the invention are sourced from waste materials.

Exemplary and preferred worm food sources may be used directly or processed by a number of process technologies including composting, grinding, shredding, fermentation, and combinations thereof. Experts in the field of composting and material processing technologies will understand the equipment and processing conditions required to complete size reduction and to efficiently utilize microorganisms to break down organic materials prior to feeding to the worms. Preferred feedstock processing technologies include grinding, composting, and use of screens and trommels so that feedstock particle sizes are less than one-half inch. Experts in the field of composting will also recognize the need to control compost temperature before introduction to the worm systems.

Worm castings produced in accordance wi the present invention are processed before production of solid shaped forms and unitary bodies in order to remove worms and reduce undigested feed-stock. Exemplary methods for removal of worms and pieces of feed-stock not consumed include the use of screens and trommels. Preferred particle sizes pass one-quarter inch screens.

Exemplary equipment useful for the preparation of solid shaped forms and unified bodies of the invention include extrusion, molding, compression, and combinations thereof. Preferred methods of preparation incorporate temperatures between 20 and 150 degrees Fahrenheit. More preferred temperatures are between 20 and 100 degrees Fahrenheit. Those expert in the art of molding, extrusion, and sculpting will understand the appropriate conditions of worm casting elasticity and plasticity required to utilize each type of manufacturing method and that moisture content is a critical variable in producing suitable processing material. Moisture contents between 50% and 90% are preferred. Exemplary surface materials for solid form production equipment include stainless steel, aluminum, thermoplastics, silicon, and combinations thereof. Surface materials suitable for food and chemical manufacture are highly preferred.

Solid shapes and unified bodies of the invention can undergo post processing steps after molding and extrusion. Exemplary treatment steps include drying, hardening, and annealing. Preferred temperatures are below 130 degrees Fahrenheit with more preferred temperatures below 100 degrees Fahrenheit. Those expert in the field will understand the temperature, humidity, and time variables associated with drying and annealing objects made from organic materials in order to retain surface characteristics, porosity and to avoid stress, fractures, and deformation.

Shaped forms and unified bodies created with worm castings of the invention have the capacity to contain and carry many types of plant and soil amendments. Liquid preparation can be added to the worm castings prior to shape formation or after shape formation through spraying. Solid materials may be added to the worm castings prior to solid shape formation or after through application of coatings. Exemplary liquid additives include synthetic and natural plant nutrient compositions including those derived from fossil fuels, mined and processed minerals, animal and plant derived materials including manures, microbial formulations and biological control agents, composts, and fermented materials. Exemplary liquids include carbohydrate preparations. Preferred carbohydrates include simple sugars and complex carbohydrates such as molasses. Exemplary biological control agents include BT. Both slow release and readily available nutrients can be used including synthetic nitrogen, phosphorus and potassium sources as well as natural sources that come from plant and animal tissues and manures. Exemplary liquids also include soil additives that increase soil physical and chemical characteristics. Experts in the field will understand the nutrition requirements of different plant species in different environments and conditions as well as the soil treatment needs for different soil types including clay, sand, and loam. Exemplary soil treatments include the use of inorganic salts such as calcium sulfates and oxides, organic matter, surfactants useful for increasing water penetration, and polymers for increasing nutrient retention.

The strong binder characteristics of the worm castings of the invention facilitate the inclusion of solid materials with particle sizes much greater than that of the starting worm castings. Particulate minerals, plant materials, and animal materials can be carried in the solid shaped forms and unified bodies of the invention with stability, rigidity, and without damage to the solid shape form. This advantage of the invention allows many types of mixtures and combination products with a wide variety of application to be prepared and utilized in agriculture, horticulture, landscaping, lawn care, gardening, biomass production, and bioremediation.

Exemplary organic plant fertilizers include those obtained from grains such as corn, alfalfa, soybeans, and related feeds, meals, algae, and animal materials such as manures from livestock. It wlll be understood by experts in the field that these materials will require preparation including particle size reduction, moisture modification, and in some cases composting to ensure safety. Exemplary organic fertilizers include those with high major plant nutrient contents such as those from bats, birds, fowl, and fish.

It is common to use solid minerals, rock dusts and inorganic preparations to improve soil quality and provide plant and soil nutrlents. While a wide range of particle sizes can be used in the solid shaped forms of the invention utilizing the strong binder characteristics of the worm castings of the invention, particles smaller than one-quarter inch are preferred. Rock dusts from granite, volcanic rocks, limestone, and related mineral species are exemplary. Rock dusts with a wide variety of metal elements are preferred. Those containing high concentrations of heavy metals are to be avoided.

Shaped forms of the invention prepared with worm castings of the invention have the unique capacity of providing an optimized environment for housing, transport, propagating, and delivering beneficial soil microorganisms that improve the quality of soils and can revitalize soils and that can improve plant root systems, growth, and yield. Exemplary microorganisms that can be lncorporated into the invention include bacteria, fungi, protozoa, bacterla, actinobacteria, algae, mycorrhizal fungi, lichens, yeast, rotifers, nematodes, worms, and small insects. Additionally, dormant forms of organisms and reproductive components of soli organisms can be included. Exemplary dormant forms include spores, eggs, cocoons, and combinations thereof. Preferred cocoons include worm cocoons. It will be understood by experts in the field that inert and specialized solid carriers can be used to stabilize and introduce the active and dormant organisms into solid shaped forms of the invention. As example, root material is often used to inoculate viable mycorrhiza fungi into soils.

Solid shaped forms facilitate the inclusion, storage and protection of plant materials such as seeds, stems and leaves, and roots. The unique binder characteristics of the worm castings of the invention allow seeds to be included without germination. Shaped forms can be store for many months and then planted. Seeds of all types may be used with seed choice based on the final size of the shaped form. Exemplary seeds include those yielding flowers, herbs, vegetables, foods, animal feeds, species for biomass production and naturalization, bioremediation, and combinations thereof.

Solid shaped forms and unitary bodles of the invention prepared with worm castings of the invention range in color from light brown through black. Coatings on the outside surface of the solid forms allows additional plant and soil nutrients, amendments and active agents to be added to the solid forms. Coatings may also fill pores and surface defects which will alter the porosity, degradation, and stability of the solid form. Surface coating also provides a means for coloring and enhancing the aesthetics of the solid form, Exemplary methods for applying the coating include hand painting, spraying, dipping, and combinations thereof. Exemplary methods can include primer coatings which enhance and prepare the surface for colored coatings. Exemplary primer coatings include minerals used in agriculture, horticulture, and gardening. Preferred primer coatings include calcium and magnesium sulfates, carbonates and combinations thereof. Preferred coatings are prepared with water based mediums and include natural paints prepared with natural components including oils. Preferred coatings are egg and milk based. Color agents for coatings include dyes and pigments with natural dyes and pigments preferred. Exemplary coloring agents include metal and mineral based pigments, shellacs, and insect colorants, algae, plant extracts, and combinations thereof.

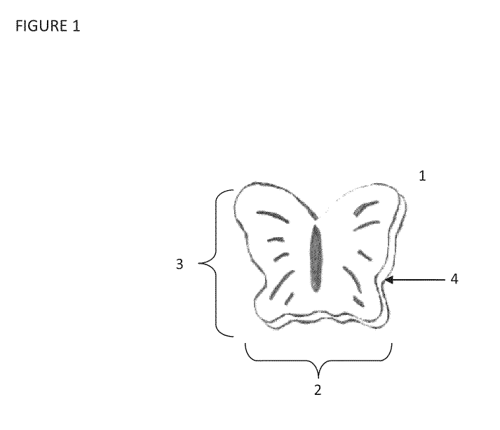

The application and utility of products of the invention are wide ranging and include use in agriculture, horticulture, gardening, landscaping, lawn care, bioremediation, and numerous other applications that involve plant and vegetative growth and care. Products of the invention can be made in a range of sizes and shapes including pellets, small balls, spikes, and commonly recognized shapes including those representing animals and plants and everyday items. Exemplary shapes and forms include, butterflies (FIG. 1), bats, fish, gingerbread men, lizards, geckos, owls, Easter Island Heads, alligators, dinosaurs, frogs, flowers, hearts, sea creatures, and the like. Each of these solid forms can be appropriately colored using coatings and natural coloring agents.

Application of solid forms of the invention can be on the soil surface, below the soil surface, and in the root zone of plants. Application can be inside building, in containers, as well as outside in gardens. The addition of moisture to the solid forms above ground or below ground begins the process of degradation of the solid form. This controlled degradation releases plant nutrients, soil nutrients, beneficial plant and root system inoculants and active agents to the soil and plant system. Variables including degree of solid form compaction, porosity and characteristics of surface coatings controls release of plant and soil components from the solid form.

Application of solid forms may also be accomplished by adding the solid form to water, dissolving and then applying the liquid solution to the soil directly, to plant foliage directly or a combination thereof. It is common to prepare aerated and non-aerated mixtures of plant and soil nutrients in liquids from a combination of different plant nutrient sources and microorganisms in order to produce high concentrations of microorganisms. The use of solid shapes of the invention for this purpose is exemplary. Likewise, inoculation of composting operations and piles with beneficial organisms is common. Use of the solid shapes of the invention is exemplary. Solid forms of the invention may be used to inoculate, seed, and support growth of aquatic plants including micro and macro algae, and water loving plants.

### DETAILED DESCRIPTION OF THE FIGURES

FIG. 1, provides a simple illustration of a solid form of the invention in the shape of a butterfly (1). The butterfly illustrated is typical of a solid form of the invention prepared with worm castings of the invention, having a width of approximately 1 inch (2) and a length of approximately 1 inch (3). Thickness (4) is approximately ¾ of one inch. The solid butterfly form contains plant and soil nutrients including nitrogen, phosphorus, and potassium inherent in the worm castings of the invention, beneficial plant and soil microorganisms including mycorrhiza fungi, and a mixture of wildflower seeds including annuals, perennials, and biannuals. The percentage of seeds in the butterfly is between 5% and 10% of the solid form dry weight.

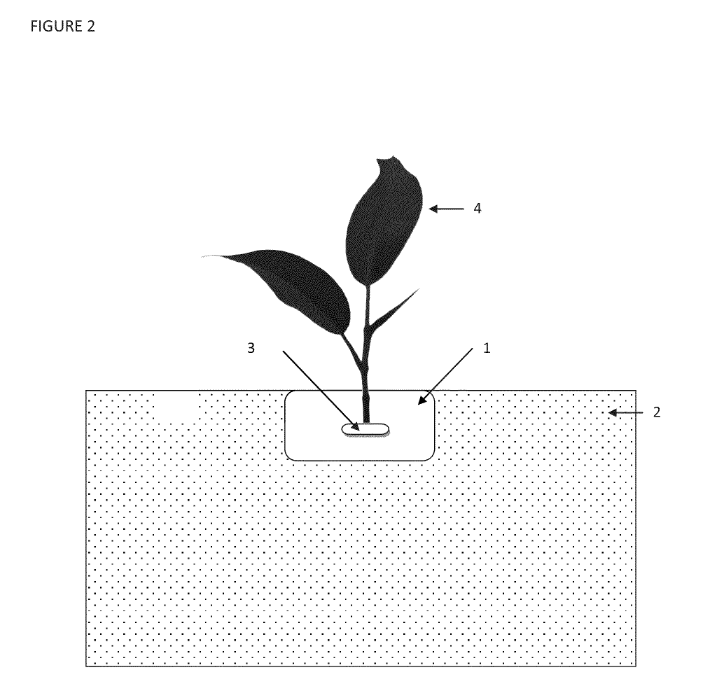

FIG. 2, provides a simple illustration of a solid form of the invention in the shape of a butterfly (1) arranged flush with the ground surface (2) for germination of a large seed (3) and subsequent growth (4). The butterfly (2) is prepared with worm castings of the invention, having a width of approximately 1 inch (2) and a length of approximately 1 inch (3). Thickness (4) is approximately ¾ of one inch. The solid butterfly form contains plant and soil nutrients including nitrogen, phosphorus, and potassium inherent in the worm castings of the invention, and beneficial plant and soil microorganisms including mycorrhiza fungi. The exemplary seed (3) is a mammoth sunflower species (helianthus).

There are unique benefits and commercial applications of the solid forms. Many of these unique application opportunities are derived from the ability to combine multiple plant and soil beneficial agents into solid shaped forms using worm castings of the invention as a material and agent binder. The elasticity and plasticity characteristics of worm castings of the invention allow solid objects of considerable size, to be contained, protected, and delivered in different applications. It is well known that healthy soil systems are beneficial to plant systems, improving plant health and yield, and decreasing the need for pesticides, herbicides, and other chemical treatments. Products of the invention allow both nutrients and soil organisms important in maintaining and revitalizing the quality of soil to be delivered in convenient and aesthetically pleasing solid shapes. Solid shapes of the invention are suitable as decorative pieces in containers and gardens and have remarkable longevity when protected from moisture.

The capacity to render worm castings of the invention into stable solid forms and unitary bodies with surface characteristics that promote direct painting and coating facilitates the use of the solid forms for education in the sciences and arts. The solid forms of the invention provide an alternative to synthetic polymer based days and related materials used for art instruction. The capacity for the surfaces of the solid forms to readily accept traditional mineral based primers such as plaster and natural paints including tempera facilitates instruction in the fine arts. The final art piece being completely functional in agriculture, gardening, horticulture and related fields.

The following exemplary descriptions are a small subset of the materials and applications that are possible with the art described herein.

### EXAMPLES

### Example 1

Worm castings were prepared in an elevated vermiculture system designed by Skolex Biotechnologies. E. fetida, worms were fed a variety of materials including vegetable and fruit waste, plant materials, coffee grounds, and cellulose materials. Worm castings were collected and tested for nutrient content. On a dry basis the worm castings contained nitrogen (2.64%), phosphorus (0.1%), potassium (0.6%) and a range of micro and trace elements including calcium, sulfur, magnesium, and iron. In addition to the microorganism populations inherent in the worm castings additional species were added in a liquid formulation and include Glomus intraradices, Glomus mosseae, Glomus aggregatum, Glomus monosporum, Glomus clarum, Glomus deserticola, Gigaspora margarita, Gigaspora brasilianum, Gigaspora etunicatum, Rhizopogon villosullus, Rhizopogon luteolus, Rhizopogon amylopogon, Rhizopogon fulvigleba, Pidolithus tinctorius, Scleroderma cepa, Scleroderma citrinum Trichoderma harzianum, Trichoderma konigii, Bacillus subtillus, Bacillus licheniformis, Bacillus azotoformans, Bacillus megaterium, Bacillus coagulans, Bacillus pumlis, Bacillus thuringiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchromyces cervisiae, Streptomyces griseues, Streptomyces lydicus, Pseudomonas aureofaceans, Deinococcus erythromyxa. A wildflower seed mixture was added to the worm castings of the invention at approximately 10% total dry mass. The worm castings of the invention including the microorganism populations and mixture of wildflower seeds were mixed thoroughly and then molded using silicone molds into the shape of a butterfly and dried at room temperature. FIG. 1 illustrates a solid form in the shape of a butterfly. After drying the rigid solid body was coated with an egg based medium containing calcium sulfate (plaster of Paris) that rendered the solid shaped unitary body grayish white in color. The solid body was subsequently coated with an egg based medium containing iron pigments that rendered the body with colors of orange, black, and yellow. The solid form butterfly was capable of absorbing water applied to the surface and the solid butterfly shape increased in weight by 100%. The volume of the solid shape expanded more than 200% when exposed to water. When planted the solid form butterfly yielded a mixture of wildflowers.

### Example 2

Worm castings were prepared in an elevated vermiculture system designed by Skolex Biotechnologies. E. fetida, worms were fed a variety of materials including vegetable and fruit waste, plant materials, coffee grounds, and cellulose materials. Worm castings were collected and tested for nutrient content. On a dry basis the worm castings contained nitrogen (2.64%), phosphorus (0.1%), potassium (0.6%) and a range of micro and trace elements including calcium, sulfur, magnesium, and iron. In addition to the microorganism populations inherent in the worm castings additional species were added in a liquid formulation and include Glomus intraradices, Glomus mosseae, Glomus aggregatum, Glomus monosporum, Glomus clarum, Glomus deserticola, Gigaspora margarita, Gigaspora brasilianum, Gigaspora etunicatum, Rhizopogon villosullus, Rhizopogon luteolus, Rhizopogon amylopogon, Rhizopogon fulvigleba, Pisolithus tinctorius, Scleroderma cepa, Scleroderma citrinum Trichoderma harzianum, Trichoderma konigii, Bacillus subtillus, Bacillus licheniformis, Bacillus azotoformans, Bacillus megaterium, Bacillus coagulans, Bacillus pumlis, Bacillus thuringiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchromyces cervisiae, Streptomyces griseues, Streptomyces lydicus, Pseudomonas aureofaceans, Deinococcus erythromyxa. A single sunflower seed (helianthus—mammoth) was added to each mold. The worm castings of the invention including the microorganism populations were then molded using silicone molds into the shape of a butterfly and dried at room temperature. FIG. 2 illustrates a solid form in the shape of a butterfly. After drying the rigid solid body was coated with an egg based medium containing calcium sulfate (plaster of Paris) that rendered the solid shaped unitary body grayish white in color. The solid body was subsequently coated with an egg based medium containing iron pigments that rendered the body with colors of orange, black, and yellow. The solid form butterfly was capable of absorbing water applied to the surface and the solid butterfly shape increased in weight by approximately 100%. The solid form butterfly was planted flush with the soil surface and watered. In five days the sunflower seed sprouted and quickly grew above the soil surface. FIG. 2 provides a simple illustration of this Example.

### Example 3

Worm castings were prepared in an elevated vermiculture system designed by Skolex Biotechnologies. E. fetida, worms were fed a variety of materials including vegetable and fruit waste, plant materials, coffee grounds, and cellulose materials. Worm castings were collected and tested for nutrient content. On a dry basis the worm castings contained nitrogen (2.64%), phosphorus (0.1%), potassium (0.6%) and a range of micro and trace elements including calcium, sulfur, magnesium, and iron. A dry commercial fish fertilizer was mixed with the worm castings at approximately 10% (dry weight). The commercial fish preparation had a nutrient content (dry basis) of nitrogen (11%), phosphorus (5%), potassium (1%). This dry fish preparation had a strong fish odor, in addition to the microorganism populations inherent in the worm castings additional species were added in a liquid formulation and include Glomus intraradices, Glomus mosseae, Glomus aggregatum, Glomus monosporum, Glomus clarum, Glomus deserticola, Gigaspora margarita, Gigaspora brasilianum, Gigaspora etunicatum, Rhizopogon villosullus, Rhizopogon luteolus, Rhizopogon amylopogon, Rhizopogon fulvigleba, Pisolithus tinctorius, Scleroderma cepa, Scleroderma citrinum Trichoderma harzianum, Trichoderma konigii, Bacillus subtillus, Bacillus licheniformis, Bacillus azotoformans, Bacillus megaterium, Bacillus coagulans, Bacillus pumlis, Bacillus thuringiensis, Bacillus stearothermiphilis, Paenibacillus polymyxa, Paenibacillus durum, Paenibacillus florescence, Paenibacillus gordonae, Azotobacter polymyxa, Azotobacter chroococcum, Sacchromyces cervisiae, Streptomyces griseues, Streptomyces lydicus, Pseudomonas aureofaceans, Deinococcus erythromyxa. The worm castings of the invention including the fish fertilizer and the microorganism inoculants were then molded using polycarbonate molds into the shape of a fish and dried at room temperature. After drying the rigid solid body was coated with an egg based medium containing calcium sulfate (plaster of Paris) that rendered the solid shaped unitary body grayish white in color. The solid body was subsequently coated with an egg based medium containing iron pigments that rendered the body with colors of orange, black, and yellow. An egg based medium with spirulina algae as a colorant was also used to provide the color green to the fish shaped solid forms. Interestingly, the final coated solid form had a much reduced odor of fish fertilizer.

### Example 4

Worm castings were prepared in an elevated vermiculture system designed by Skolex Biotechnologies. E. fetida, worms were fed a variety of materials including vegetable and fruit waste, plant materials, coffee grounds, and cellulose materials. Worm castings were collected and tested for nutrient content. On a dry basis the worm castings contained nitrogen (2.64%), phosphorus (0.1%), potassium (0.6%) and a range of micro and trace elements including calcium, sulfur, magnesium, and iron. A dry commercial bat guano fertilizer (Texas) was mixed with the worm castings at approximately 10% (dry weight). The commercial bat guano preparation had a nutrient content (dry basis) of nitrogen (11%), phosphorus (4%), potassium (1%). This dry bat guano preparation had a strong odor. In addition to the microorganism populations inherent in the worm castings additional species were added in a liquid formulation and include Glomus intraradices, Glomus mosseae, Glomus aggregatum, Glomus monosporum, Glomus clarum, Glomus deserticola, Gigaspora margarita, Gigaspora brasilianum, Gigaspora etunicatum, Rhizopogon villosullus, Rhizopogon luteolus, Rhizopogon amylopogon, Rhizopogon fulvigleba, Pisolithus tinctorius, Scleroderma cepa, Scleroderma citrinum Trichoderma harzianum, Trichoderma konigii, Bacillus subtillus, Bacillus licheniformis, Bacillus azotoformans, Bacillus megaterium, Bacillus coagulans, Bacillus pumlis, Bacillus thuringiensis, Bacillus stearothermiphilis, Paenibcicillus polymyxa, Paenibacillus durum, Paenibacillus florescence, Paenibacillus gordonae, Azotobacter polymyxa, Azotobacter chroococcum, Sacchromyces cervisiae, Streptomyces griseues, Streptomyces lydicus, Pseudomonas aureofaceans, Deinococcus erythromyxa. The worm castings of the invention including the bat guano fertilizer and the microorganism inoculants were then molded using silicone molds into the shape of a bat and dried at room temperature. After drying the rigid solid body was coated with an egg based medium containing calcium sulfate (plaster of Paris) that rendered the solid shaped unitary body grayish white in color. The solid body was subsequently coated with an egg based medium containing iron pigments that rendered the body with colors of orange, black, and yellow. Interestingly, the final coated solid form had a much reduced odor.

1. A nutritional composition for plants and soil organisms comprising worm castings in a solid unitary body.

2. The body of claim 1 further comprising a form, wherein the form is selected from the group including naturally occurring forms, inanimate forms, sculptures, abstract forms, pellets, briquettes, spikes, and combinations thereof.

3. The body of claim 1 further comprising natural plant and soil nutritional materials, wherein the natural plant and soil nutritional materials are selected from the group of materials derived from animal materials, plant materials, mineral materials, and combinations thereof.

4. The body of claim 1 further comprising synthetic plant and soil nutritional materials, wherein the synthetic plant and soil nutritional materials are selected from the group of materials that contain nitrogen, carbon, phosphorus, potassium, metals, and combinations thereof.

5. The body of claim further comprising naturally occurring agents selected from the group of naturally occurring agents that act as pesticides, herbicides, algaecides, insect deterrents, pest deterrents, and combinations thereof.

6. The body of claim 1 further comprising synthetic agents selected from the group of synthetic agents that act as pesticides, herbicides, algaecides, insect deterrents, pest deterrents, and combinations thereof.

7. The body of claim 1 further comprising viable plant materials, where the viable plant materials are selected from the group including seeds, stems, leaves, roots, and combinations thereof.

8. The body of claim 1 further comprising viable fungal materials, where the viable fungal materials are selected from the group including spores, root materials, fungi preparations, and combinations thereof.

9. The body of claim 1 further comprising viable bacterial materials, where the viable bacterial materials are selected from the group including cells, plant and animal materials, bacterial preparations, and combinations thereof.

10. The body of claim 1 further comprising microorganisms known to inhabit soils.

11. The body of claim 1 further comprising animal propagation components, where the animal propagation components are selected from the group including eggs, cocoons, larvae, and combinations thereof.

12. The worm castings of claim 1 prepared using vermiculture systems conducted on the around.

13. The worm castings of claim I prepared using vermiculture systems conducted above ground.

14. The body of claim 1 prepared using techniques selected from the group of preparation techniques including screening, sieving, aging, drying, annealing, compressing, molding, extruding, shearing, grinding, milling, low temperature treatment, heat treatment, and combinations thereof.

15. The body of claim 1 further processed using techniques selected from the group of techniques including sanitizing processes, sterilization processes, chemical processes, radiative processes, thermal processes, radioactive processes, steam processes, and combinations thereof.

16. The body of claim 1 used below the ground surface, on the ground surface, or a combination thereof.

17. The body of claim 1 used to prepare a liquid solution for use directly on the ground, on plant surfaces, or combinations thereof.

18. The body of claim 1 further comprising a coating wherein the coating is selected from the group of coatings including natural dyes, shellacs, natural paints, milk paints, egg paints, colored materials, fertilizer materials, minerals, pigments, dyes, clay-dye formulations, and combinations thereof.

19. The body of claim 1 which expands when exposed to liquids, solutions, moisture, or combinations thereof.

20. The body of claim 1 that comprises pores, holes, cracks, exclusions, or combinations thereof.

21. The body of claim 1 that is used to germinate seeds.

22. The body of claim 1 that comprises decorative components selected from the group of decorative components including plastic components, resins, textiles, metal components, and combinations thereof.

23. The body of claim 1 used to inoculate beneficial organisms into plant and soil materials, planting holes, plant propagation systems, and combinations thereof.

24. The coatings of claim 18 comprising plant and soil nutrients.

25. The liquids of claim 17 used to treat plant diseases.
